(19) United States
(12) Patent Application Publication
(10) Pub. No.: US 2012/0223528 A1
(43) Pub. Date: Sep. 6, 2012

(54) WIND ENERGY CAPTURING DEVICE

(76) Inventor: Sergio Luis Mena Vergara, Santiago (CL)

(21) Appl. No.: 13/509,491

(22) PCT Filed: Nov. 10, 2010
(86) PCT No.: PCT/IB10/55115

§ 371 Date: May 11, 2012

(30) Foreign Application Priority Data
Nov. 12, 2009 (CL) 2068-2009

(51) Int. Cl. F03D 9/00

(52) U.S. Cl. 290/55

(57) ABSTRACT

A wind power-harvesting device to produce electricity that acts as a wind collector and electricity generator formed by: a) a static vertical collector cylinder (2) comprising 20 static collector channels (4), a spherical deflecting casket (3) and a complementary spherical deflector casket (3′), to collect winds from any cardinal point and deflect said winds from a horizontal direction to a vertical ascending direction; b) a static vertical flow accelerating truncated cone (5) assembled on top of the static collector cylinder (2) and formed by 20 complementary radial collector partition walls (1′), which form 20 flow accelerating channels (4′) that increase the wind rate around twice and provide a turbine body (6) with a flow with potency density equal to 8 times that of the location, expressed in watts/m2 and an energetic efficiency in said turbine body around 87%; c) a vertical axe vertical ascending flow turbine; and d) a generator (8) with electrical and mechanical characteristics compatible with the local interconnected electric network.

### FIELD OF APPLICATION

The object of the invention (wind engine) and the application field (generation of electric power through a more efficient harvesting of wind energy) are described.

The wind power-harvesting device for electric power generation is a form of wind engine that uses a special wind flow channeling to significantly increase the available power density for a vertical axe and vertical ascending flow turbine with a turbine body and a large surface blade rotor, to achieve large power.

### BACKGROUND OF THE INVENTION

The state of the art and the technical problem presented are described if a document close to the invention has been found in the search of the state of the art. The differences between the application and the former invention are described.

The wind engine industry has been developed and massively grows based on a wind turbine model that is a horizontal axe and flow turbine with no turbine body and free low surface blade rotor, mounted on a direction-adjustable device on a tower.

On the other hand, the growing scarcity of energetic resources at world level has been a potent incentive for the development of “non-conventional renewable energies”. In this context, the abundance of winds in diverse places has put the interest of a number of manufacturers on the development of varied designs to optimize the use of this resource, reduce the investment costs and produce even more potent units. It would be long to detail the multiple developed solutions. However, for the purpose of the advantages of the present invention, it is enough to mention that all of them have a common final energy conversion level, which can be greatly improved.

The wind power-harvesting device to produce electricity of the present invention constitutes a new precedent in relation to this important conversion parameter. In the studied documents: ES259880, ES2008/000341, U.S. Pat. No. 6,952,058 B2, interesting solutions are found, which point to savings in installation space, design of easily built and economic rotors, multiple rotors to make the most of wind availability and direction.

### DETAILED DESCRIPTION OF THE INVENTION

The design of this invention greatly satisfies these objectives and also incorporate new principles that form a different and exclusive solution:
Change of the direction and flow rate of the wind entering into the wind power-harvesting device to produce electricity.
Increase of the wind power density available in the turbine body (6).
Reduction of the entry area of the turbine.
Reduction of the friction forces in the turbine supports.
Substantial increase of the final conversion efficiency.
Optimization of the available power-harvesting in the turbine, with the incorporation of a turbine body (6) or load chamber and rotor (7), with structural articulated blade supporting modules (7.1), FIG. 4.
Maximization of the power generation, by developing a vertical axe ascending flow turbine with high power density winds, with large surface blades rotating in a horizontal plane and gravitating on structural articulated blade supporting modules (7.1) to distribute loads and scale up to large potencies, FIGS. 4 and 5.

An essential component of the wind power-harvesting device to produce electricity is the static vertical collector cylinder (2), formed by 20 static collector channels (4), shown in FIGS. 1 and 2 and consisting respectively of two radial collector partition walls (1), a spherical deflector casket (3) and a complementary spherical deflector casket (3′). These have two functions: harvesting wind flows from any cardinal point and deflecting them from a horizontal to a vertical ascending component.

Another important component is formed by the static vertical flow accelerating truncated cone (5), FIG. 1, the function of which is the gradual decrease of the duct section in each complementary flow accelerating channel (4′), by which the air flow increases its rate twice and the wind power density increases eight times in terms of watts/square meter at the inlet of the turbine body (6), plot in FIG. 6. In the experimental model assayed in the wind-engineering laboratory, the rate at the inlet of the static vertical collector cylinder (2) was 6.8 m/s, whereas at the outlet of each complementary static collector channel (4′) or at the inlet of the turbine body (6) the rate was 13.97 m/s, i.e. more than twice the initial rate.

The plot in FIG. 6 illustrates the wind power density increase produced by using the geometry of this device, roughly 8 times that of the wind power density in place. Given that this airflow enters vertically upwards into the turbine, it could be said that the rotor, with no free blades mounting, floats in the vertical ascending wind current, thus minimizing the friction on the sliding support rollers.

The evaluation of the final energy conversion efficiency of the wind power-harvesting device to produce electricity is based on the following parameters measured in the laboratory and known according to the performances of the alternators and turbines. Those are:
Wind power-harvesting device to produce electricity: 87%.
Wind turbine: 80%
Alternator: 94%

Consequently, the final energy conversion efficiency of the wind power-harvesting device to produce electricity could be around 0.87×0.80×0.94=65%.

Considering that according to the present state of the art of wind generators the efficiency range is between 26% and 30%, this wind power-harvesting device to produce electricity is, probably, and extraordinary advancement.

To better understand the wind power-harvesting device to produce electricity, it will be described based on a preferred embodiment that is illustrated in the following figures, which has only an illustrative character and do not limit the scope of the invention, the particular dimensions, the amount of the illustrated elements or de exemplified support means.

### BRIEF DESCRIPTION OF THE DRAWINGS

FIG. 1 is a quarter cut side view of the wind power-harvesting device to produce electricity, showing each and every integral component.

FIG. 2 is a top view of the wind power-harvesting device to produce electricity, showing the distribution and conformation of the integral components.

FIG. 3 is a plant view along c-c′, showing the distribution of the static collector channels (4) and the angular section with respect to the wind direction, wherein the power efficiency of the four channels located in this angular section at 36 degrees at both sides of the wind direction reaches 87%.

FIG. 4 represents a perspective view of the turbine, showing the turbine body (6) with bottom structures (6.1) and top structures (6.2), supporting the rolling tracks for the rotor supporting rollers with modular articulated blade supporting structures (7.1), FIG. 4.

FIG. 5 shows a detail of the modular articulated blade supporting structures (7.1), in one or various sectors, having an articulated end and another end supported on a rolling track, side view of FIG. 5.1, also showing the blade (7.2), and FIG. 5.2 showing the adjustable angular position of the blade (7.2), and plant view of FIG. 5.3 showing the angular section that spans the articulated modular blade supporting structure (7.1) and the collar-mass (7.3) that allows transmitting the blade torque force to the axle and form the supporting articulations of the articulated modular blade supporting structures (7.1).

FIG. 6 shows a plot for the wind power density in the device inlet and available for the turbine as a function of the wind mean rate.

### DETAILED DESCRIPTION OF THE INVENTION

Detailed description of the wind power-harvesting device to produce electricity:

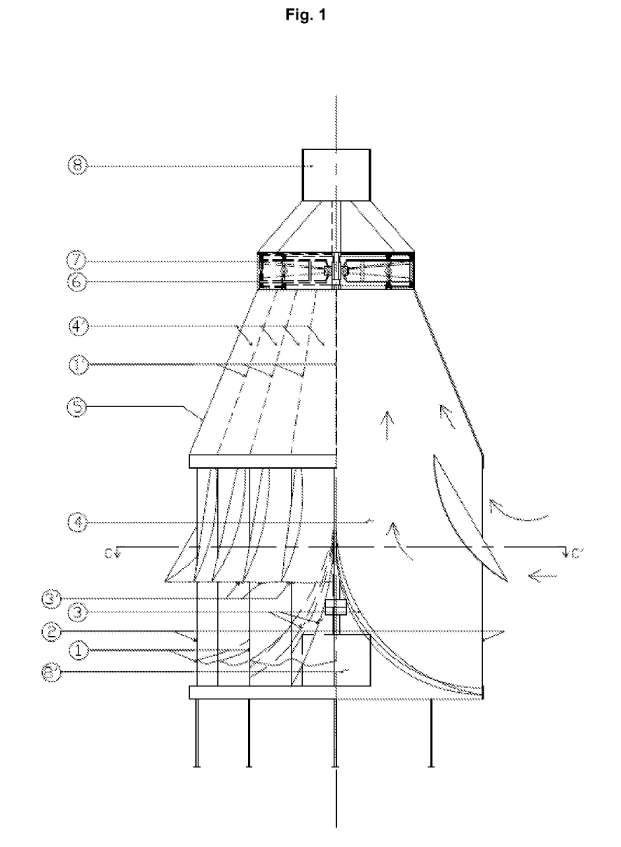

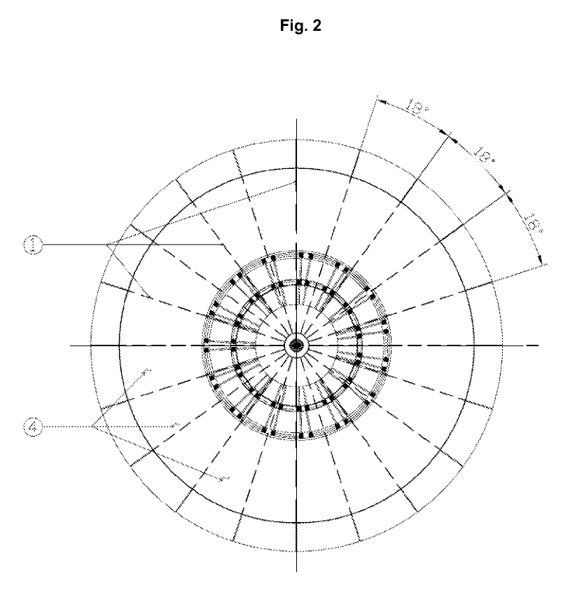

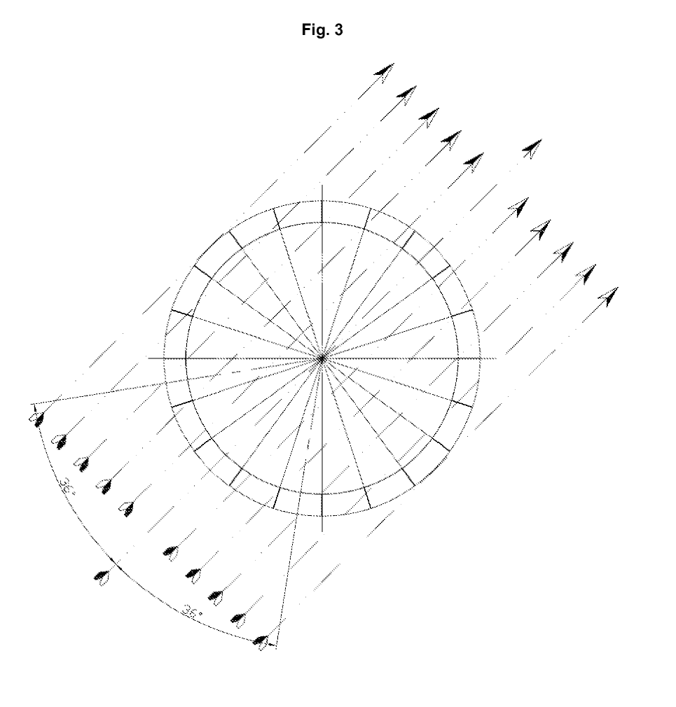

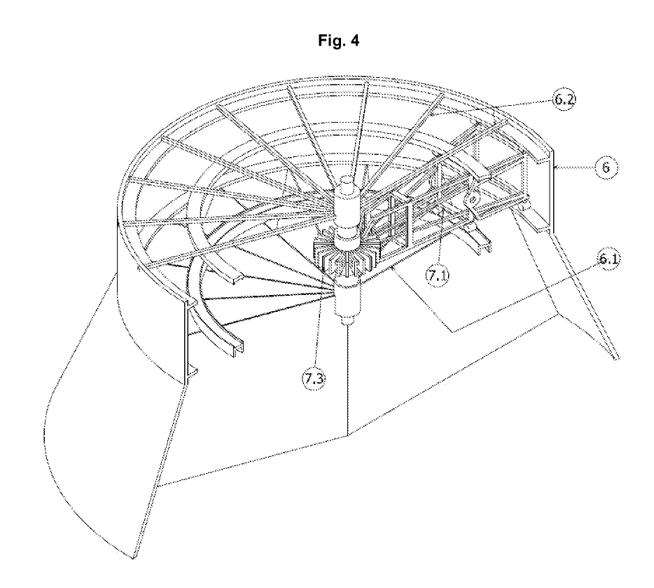

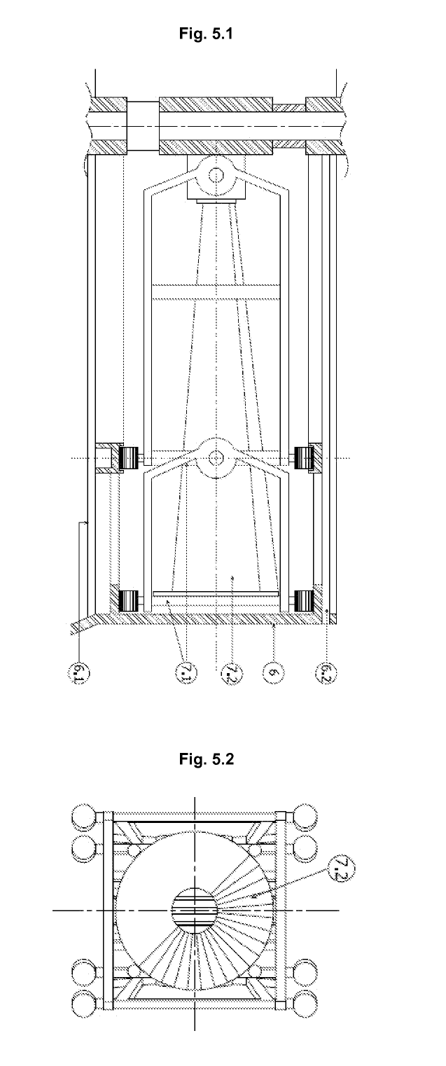

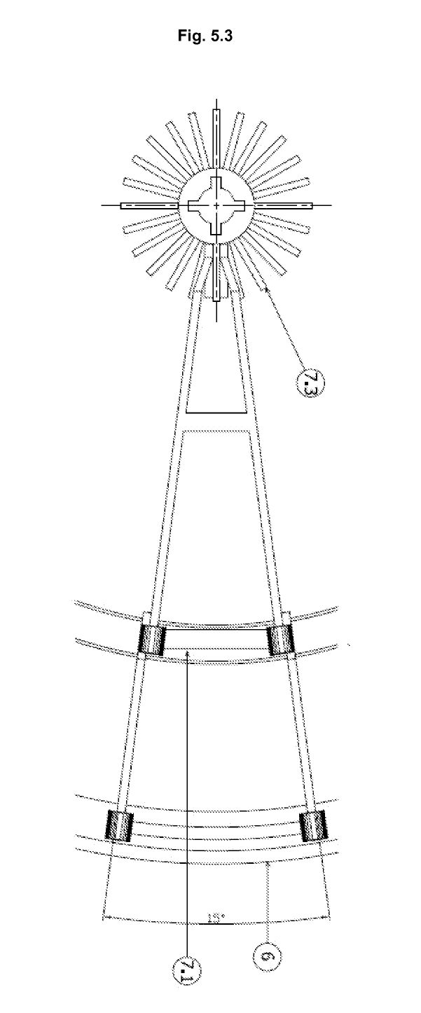

In FIG. 1, a quarter cut side view of the wind power-harvesting device to produce electricity is shown, which comprises:
A static vertical collector cylinder (2)
A static vertical flow accelerating truncated cone (5)
A vertical axe and ascending vertical flow turbine, with a turbine body (6) and a rotor (7)
An electric generator (8)

The static vertical collector cylinder (2) is formed by 20 radial partition walls (1) arranged to form 18 degrees angles between each other and distributed in 360 degrees around the cylinder.

To determine the dimension of the components of the wind power-harvesting device to produce electricity, we will use Newton's law expression:
E=½×m×V²
E=Kinetic energy of a moving mass
m=mass
V=velocity

Newton's expression applied to wind is equal to:
Wc=½×d×A×V³ (watts)
Wc=Power harvested by the device, expressed in watts.
d=air density, which we will assume to be 1.1 kg/m³
A=area of wind harvesting of the device, projected on the plane perpendicular to the flow axe, in square meters.
A=2 sin 36°×R×1.67×R=2×0.587785252×R×1.67 R=1.9632 R²
V=mean local wind rate, in m/s.

Replacing terms, we obtain:
Wc=½×1.1×1.9632 R²×V³=1.08×R²×V³

Solving for R, we obtain:

$$R = √ \frac{Wc}{1.08 {V}^{3}}$$

However, since the total energetic efficiency (N) of the device is:

$$N = \frac{W b}{Wc} = 0.65$$

Solving for Wc, we obtain:
Wc=Wb/0.65
Wb=Potency in generator terminals, expressed in watts.

Finally, the static collector cylinder (2) radius, R, is:

$$R = √ \frac{W b / 0.65}{1.08 {V}^{3}}$$

The static vertical cylinder collector (2) radius can be calculated from the potency to be generated, expressed in watts, and the mean local wind rate, expressed in m/s. For this, the total device losses are added up to the potency that has to be available in the generator terminals, expressed in watts, and this is divided by the total efficiency factor, i.e. 0.65, and this quotient is divided by 1.08 times the mean local wind rate in m/s to the third potency, and then the square root of this quotient is obtained to get the static vertical collector cylinder (2) radius expressed in meters.

In this way, the radial collector partition walls (1) have a width that is equivalent to the radius determined above, and a height equal to 1.67 times said radius, to ensure the overlap of the flow deflecting caskets (3) and the secondary flow deflecting caskets (3′), FIG. 1.

Twenty (20) deflecting spherical caskets (3) are located at the base of the static vertical cylindrical collector (2), each having a radius equal to the radius of the static vertical collector cylinder (2), and the center of which is respectively in the bisector plane of the angle formed by two adjacent radial collector partition walls (1), with the generating spheres being tangent to the base plane of the static vertical cylindrical collector (2) and the axe thereof, FIG. 1.

Twenty (20) complementary deflecting spherical caskets (3′) are located at the top of the static vertical cylindrical collector (2), the generating spheres thereof having their centers respectively at the intersection of the top basal plane of the static vertical cylindrical collector (2) with the bisector plane of the angle formed by two adjacent radial collector partition walls (1), respectively, and at a distance of 1.67 radii from the static vertical cylindrical collector (2) and having an angle with respect to the center of 60 degrees, FIG. 1.

The static vertical cylindrical collector (2) is formed by 20 static collector channels (4) respectively formed by two static radial partition walls (1), a deflecting spherical casket (3) and a complementary deflecting spherical casket (3′), FIG. 1.

The static vertical flow accelerating truncated cone (5) is located over and assembled to the static vertical cylindrical collector (2), with a generator line angle of 22.5 degrees, FIG. 1.

Twenty (20) complementary radial partition walls (1′) are located inside the static vertical flow accelerating truncated cone (5), in the same plane as the radial collector partition walls (1) and forming 20 flow accelerating channels (4′) aligned with the static collector channels (4), FIG. 1.

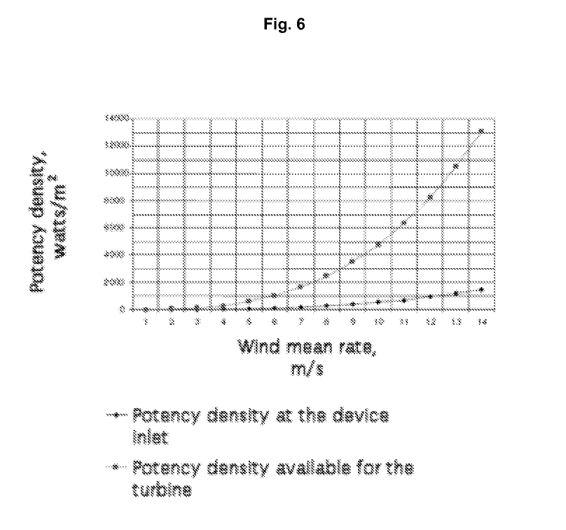

A cylinder is located over the static vertical flow accelerating truncated cone (5), which forms the turbine body (6), FIG. 1. To determine the diameter of the turbine body, we need to know the available residual potency in the 4 inlet openings of the turbine body, which we can determine by multiplying the total harvested potency times the efficiency of the device available at the turbine body, i.e. 0.87. After determining the residual potency available from these 4 inlets, expressed in watts, we can calculate the total surface of the inlet openings, dividing this value by the potency density available for the turbine, in watts/m², which corresponds to the mean local wind rate, plot in FIG. 6. The determined surface corresponds to 4 inlets from a total of 20, in such a way that the total turbine surface is 5 times this value. To determine the diameter of the turbine body, it is necessary to divide the total surface by 0.785 and calculating the square root thereof.

The height of the static vertical flow accelerating truncated cone (5) is equal to the difference between the radius of the static vertical collector cylinder (2) radius and the turbine body (6) radius, divided by 0.414 (tangent of 22.5 degrees).

Aligned with the turbine body (6) axe and on top of this, an electric generator (8) is located; as an alternative location, the generator (8′) is located under the deflecting spherical caskets (3), FIG. 1.

As an example and as a comparison with available wind turbines, the following table is presented, with the dimensions of projected devices for several capacities, for winds with a mean rate of 13 m/s.

The devices can be installed, preferentially, in mountain valleys, natural channels, communicating vessels of winds flowing between continental geographic areas adjacent to high peaks that act as a contention wall for atmospheric air masses subject to pressure differences. The pressure difference determines the rate and flow direction of the winds, and also cyclically changes its direction over 24 hours, thus producing variable flow directions and reversible flows. See, as an example, the satellite meteorological maps in www.meteochile.cl and the observations of the Raco wind in the Maipo River valley.

Design of a wind power-harvesting device to produce electricity.

TABLE 1
for potencies from 1 to 50 MW, for a mean wind rate of 13 m/s.

| Potency (MW) | | | Size of Components (m) | | | | | |
|---|---|---|---|---|---|---|---|---|
| Available | | Available | Collector | | | | Truncated | |
| for the | Harvested by | for the | cylinder (2) | | Turbine body (6) | | cone (5) | Total |
| generator | the device | turbine | Radius | Height | Diameter | Height | Height | height |
| 1 | 1.538 | 1.338 | 25.5 | 42.5 | 28.5 | 14.2 | 27 | 84 |
| 1.65 | | | | | 82 | wind turbine | | 119 |
| 2 | 3.077 | 2.677 | 36 | 60 | 40 | 20 | 38 | 118 |
| 5 | 7.692 | 6.692 | 57 | 95 | 64 | 32 | 60 | 187 |
| 10 | 15.385 | 13.385 | 80.5 | 135 | 90 | 45 | 86 | 266 |
| 20 | 30.769 | 26.769 | 114 | 190 | 127 | 64 | 121 | 375 |
| 30 | 46 | 40 | 140 | 233 | 156 | 78 | 150 | 461 |
| 40 | 62 | 54 | 161 | 269 | 180 | 90 | 171 | 530 |
| 50 | 77 | 67 | 180 | 300 | 202 | 101 | 191 | 592 |

1. A wind power-harvesting device to produce electricity that acts as a wind collector and electricity generator, wherein said device comprises:
a) a static vertical collector cylinder formed by 20 static collector channels, respectively formed by two radial collector partition walls arranged at an angle of 18 degrees between each other and distributed around 360 degrees, a deflecting spherical casket, and a complementary deflecting spherical casket, wherein said static collector channels collect wind from any cardinal point and deflect said wind from a horizontal direction to a vertical ascending direction;
b) a static vertical flow accelerating truncated cone assembled on top of the static collector cylinder and formed by 20 complementary radial collector partition walls, arranged and distributed in the same way as the radial collector partition walls, thus forming 20 flow accelerating channels aligned with the static vertical collector channels, in such a way as to increase the wind rate around twice and providing a turbine body with a flow with potency density equal to 8 times that of the location, expressed in watts/m² and an energetic efficiency in said turbine body around 87%;
c) a vertical axe and vertical ascending flow turbine, formed by a turbine body with a cylindrical envelope, bottom structures located on top of the top edge of the complementary radial collector partition walls, and top structures, which allow controlling the wind flow action and supporting the rolling tracks for supporting rollers of 24 modular blade supporting structures, which form the rotor and are each formed by one or several pieces articulated at the inner end and supported at the outer end on rollers for sliding on rolling tracks, with the object of distributing the load over the blades and decreasing the bending moment, to achieve light structures able to support large demands that are the product of the large potency density available in the turbine and the large surface of the blades, in order to scale up to large potencies, from 1 to 50 MW, according to the development of construction technologies; and
d) a generator with electrical and mechanical characteristics compatible with the local interconnected electric network.

2. The wind power-harvesting device to produce electricity according to claim 1, wherein said static vertical collector cylinder is formed by 20 radial collector partition walls arranged at an angle of 18 degrees between each other, to harvest wind with low pressure losses.

3. The wind power-harvesting device to produce electricity according to claim 1, wherein said static vertical collector cylinder is formed by 20 radial collector partition walls distributed around 360 degrees, to harvest winds from any cardinal point.

4. The wind power-harvesting device to produce electricity according to claim 1, wherein said static vertical collector cylinder is formed by 20 radial collector partition walls, each respectively having a spherical deflecting casket at the bottom base, and a complementary spherical deflector casket at the top base, to direct the wind flow from a horizontal direction to a vertical ascending direction.

5. The wind power-harvesting device to produce electricity according to claim 1, wherein said static vertical collector cylinder has a static vertical flow accelerating truncated cone on top to increase the wind speed twice by a Venturi effect and consequently increase the potency density up to 8 times the local wind potency density, in terms of watts/square meter, available inside the turbine body.

6. The wind power-harvesting device to produce electricity according to claim 1, wherein said static vertical collector cylinder is formed by 20 static collector channels, each respectively formed by 2 radial collector partition walls, a spherical deflecting casket and a complementary spherical deflector casket, to collect winds from any cardinal point and deflect said winds from a horizontal direction to a vertical ascending direction.

7. The wind power-harvesting device to produce electricity according to claim 1, wherein said static vertical flow accelerating truncated cone is formed by 20 complementary radial collector partition walls, in line with the radial collector partition walls and form together with the flow accelerating truncated cone mantle the flow accelerating channels that increase the wind rate around twice, which produces an increase of 8 times in the potency density available in the turbine body, with an energetic efficiency around 87%.

8. The wind power-harvesting device to produce electricity according to claim 1, wherein said device comprises a turbine rotor with vertical axe and vertical ascending flow, and a turbine body.

9. The wind power-harvesting device to produce electricity according to claim 1, wherein said turbine rotor comprises 24 structural blade supporting modules, each comprising one or several pieces articulated at the inner end and supported at the outer end on rollers for sliding on rolling tracks, with the object of distributing the load over the blades and decreasing the bending moment, to design light structures able to support large demands and also to scale up to large potencies, from 1 to 50 MW, according to the development of construction technologies

10. The wind power-harvesting device to produce electricity according to claim 1, wherein said device comprises a generator with electrical and mechanical characteristics compatible with the local interconnected electric network.
